(19) United States
(12) Patent Application Publication
(10) Pub. No.: US 2023/0300095 A1
(43) Pub. Date: Sep. 21, 2023

(54) AUDIO-ENABLED MESSAGING OF AN IMAGE

(71) Applicant: Tencent Technology (Shenzhen) Company Limited, Shenzhen (CN)

(72) Inventor: Xiaodan CHEN, Shenzhen (CN)

(73) Assignee: Tencent Technology (Shenzhen) Company Limited, Shenzhen (CN)

(21) Appl. No.: 18/201,614

(22) Filed: May 24, 2023

Related U.S. Application Data
(63) Continuation of application No. PCT/CN2022/119778, filed on Sep. 20, 2022.

(30) Foreign Application Priority Data
Nov. 17, 2021 (CN) 202111362112.8

(51) Int. Cl. H04L 51/10; G06F 3/16; G06F 3/0484

(52) U.S. Cl. CPC H04L 51/10; G06F 3/165; G06F 3/0484

(57) ABSTRACT

A method for audio-enabled messaging of an image is provided. In the method, a messaging interface is displayed. An image selection interface is displayed in response to a first user operation via the messaging interface. The image selection interface is configured to display at least one image for selection by a user. An audio-enabled message that includes an image that is selected from the at least one image by the user is displayed in the messaging interface. The audio-enabled message includes the selected image and audio information that is determined to be associated with the selected image.

### RELATED APPLICATIONS

The present application is a continuation of International Application No. PCT/CN2022/119778 filed on Sep. 20, 2022, which claims priority to Chinese Patent Application No. 202111362112.8 filed on Nov. 17, 2021. The entire disclosures of the prior applications are hereby incorporated by reference.

### FIELD OF THE TECHNOLOGY

This disclosure relates to the field of computer and Internet technologies, including to an emoji package display method and apparatus, an associated sound acquisition method and apparatus, a device, and a storage medium.

### BACKGROUND OF THE DISCLOSURE

On social platforms, users may communicate with each other through emoji packages.

In the related art, a user may select specific emoji packages for transmission when communicating with other users, and after the transmission, the emoji packages transmitted by the user are displayed on a chat session interface.

However, in the related art, the communication based on emoji packages can be dull.

### SUMMARY

Embodiments of this disclosure provide a method for audio-enabled messaging of an image (such as an emoji package display method) and apparatus, a method for obtaining audio information for an audio-enable message (such as an associated sound acquisition method) and apparatus, a device, and a non-transitory computer-readable storage medium, which support display of audio messages corresponding to images (such as emoji packages), so that communication based on images is not restricted to communication through the images, and the communication through images becomes more diverse, thereby providing users with more desirable messaging (or chat) atmosphere.

According to an aspect of the embodiments of this disclosure, a method for audio-enabled messaging of an image is provided. The method is performed by a terminal device for example. In the method, a messaging interface is displayed. An image selection interface is displayed in response to a first user operation via the messaging interface. The image selection interface is configured to display at least one image for selection by a user. An audio-enabled message that includes an image that is selected from the at least one image by the user is displayed in the messaging interface. The audio-enabled message includes the selected image and audio information that is determined to be associated with the selected image.

According to an aspect of the embodiments of this disclosure, a method for obtaining audio information for an audio-enabled message is provided. The method is performed by a computer device for example. In the method, feature information of an image to be included in the audio-enabled message is obtained. Audio information that is determined to be associated with the image is obtained according to the feature information. Associated audio information of the image to be included in the audio-enabled message with the image is generated based on the obtained audio information

According to an aspect of the embodiments of this disclosure, an information processing apparatus is provided. The information processing apparatus includes processing circuitry that is configured to displaying a messaging interface. The processing circuitry is configured to display an image selection interface in response to a first user operation via the messaging interface. The image selection interface is configured to display at least one image for selection by a user. The processing circuitry is configured to display, in the messaging interface, an audio-enabled message that includes an image that is selected from the at least one image by the user. The audio-enabled message includes the selected image and audio information that is determined to be associated with the selected image.

According to an aspect of the embodiments of this disclosure, an information processing apparatus is provided. The information processing apparatus includes processing circuitry that is configured to obtain feature information of an image to be included in the audio-enabled message. The processing circuitry is configured to obtain audio information that is determined to be associated with the image according to the feature information. The processing is configured to generate associated audio information of the image to be included in the audio-enabled message with the image based on the obtained audio information.

According to an aspect of the embodiments of this disclosure, a computer device is provided, including a processor and a memory, the memory storing a computer program, the computer program being loaded and executed by the processor to implement any of the above methods.

In an example, the computer device includes a terminal device or a server.

According to an aspect of the embodiments of this disclosure, a non-transitory computer-readable storage medium is provided, storing instructions which when executed by a processor cause the processor to implement any of the above methods.

According to an aspect of the embodiments of this disclosure, a computer program product is provided, including a computer program, the computer program being stored in a computer-readable storage medium, and a processor reading the computer program from the computer-readable storage medium and executing the computer program to implement any of the above method.

Technical solutions provided in the embodiments of this disclosure may bring the following beneficial effects:

In an example, a first emoji package and associated sound information of the first emoji package are displayed through an audio emoji message corresponding to the first emoji package. That is to say, when users transmit the first emoji package, they can communicate through both the first emoji package and the associated sound information of the first emoji package, so that the communication based on the emoji packages is not restricted to image communication, and the communication through emoji packages becomes more diverse, thereby providing users with more desirable chat atmosphere. Moreover, the associated sound information of the first emoji package is the sound information associated with the first emoji package obtained by matching from the sound information database. That is to say, the audio emoji message corresponding to the first emoji package may be generated by matching with existing sound information without a need to record the first emoji package in advance or in real time, which reduces the acquisition overheads and time costs of the associated sound information, thereby reducing the generation overheads and time costs of the audio emoji message. The sound information in the sound information database is applicable to a plurality of emoji packages. Therefore, the audio emoji messages respectively corresponding to the plurality of emoji packages may be acquired without a need to record the emoji packages one by one, which can effectively improve the efficiency of generating audio emoji messages in the case of a large number of emoji packages.

### BRIEF DESCRIPTION OF THE DRAWINGS

FIG. 1 is a schematic diagram of an emoji package display system according to an embodiment of this disclosure.

FIG. 2 is an exemplary schematic diagram of an emoji package display system.

FIG. 3 is a flowchart of an emoji package display method according to an embodiment of this disclosure.

FIG. 4 to FIG. 5 are exemplary schematic diagrams of a chat session interface.

FIG. 6 is a flowchart of an emoji package display method according to an embodiment of this disclosure.

FIG. 7 is an exemplary schematic diagram of an emoji package selection interface.

FIG. 8 is an exemplary schematic diagram of a chat session interface.

FIG. 9 is a flowchart of a method for acquiring an associated sound of an emoji package according to an embodiment of this disclosure.

FIG. 10 is an exemplary schematic diagram of a function setting interface.

FIG. 11 is an exemplary schematic flowchart of an emoji package display mode.

FIG. 12 is a block diagram of an emoji package display apparatus according to an embodiment of this disclosure.

FIG. 13 is a block diagram of an emoji package display apparatus according to an embodiment of this disclosure.

FIG. 14 is a block diagram of an apparatus for acquiring an associated sound of an emoji package according to an embodiment of this disclosure.

FIG. 15 is a block diagram of an apparatus for acquiring an associated sound of an emoji package according to an embodiment of this disclosure.

FIG. 16 is a structural block diagram of a terminal device according to an embodiment of this disclosure.

### DISCLOSURE

FIG. 17 is a structural block diagram of a server according to an embodiment of this disclosure.

### DESCRIPTION OF EMBODIMENTS

FIG. 1 is a schematic diagram of an emoji package display system according to an embodiment of this disclosure. The emoji package display system may include a terminal 10 and a server 20.

The terminal 10 may be an electronic device such as a mobile phone, a tablet computer, a game console, an e-book reader, a multimedia playback device, a wearable device, an on-board terminal, or a personal computer (PC). A client of an application may be installed in the terminal 10. The application is any application with an emoji package display function, such as a social application, a shopping application, or a game application. In an example, the application may be an application that needs to be downloaded and installed, or may be a click-to-run application, which is not limited in this embodiment of this disclosure. The above emoji package may be a static image or a dynamic image, which is not limited in this embodiment of this disclosure. In this embodiment of this disclosure, the terminal device may also be referred to as a terminal.

The server 20 is configured to provide a background service for the client installed of the application in the terminal 10. For example, the server 20 is a background server of the above application. The server 20 may be one server, a server cluster including a plurality of servers, or a cloud computing service center. In an example, the server 20 provides backend services for applications in a plurality of terminals 10 simultaneously.

The terminal 10 and the server 20 may communicate with each other over a network.

In an example, the server 20 provides at least one of the functions such as data storage, data processing, or data transmission for the terminal 10.

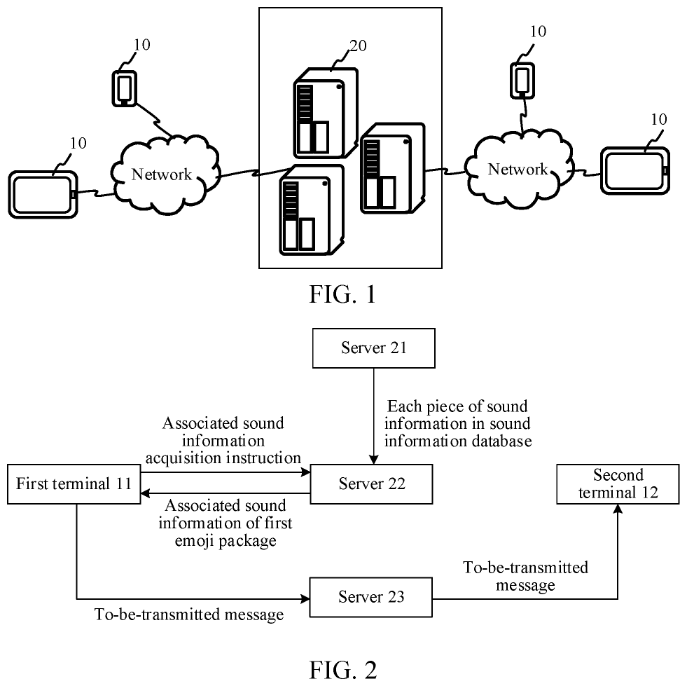

Exemplarily, as shown in FIG. 2, the server 20 includes a server 21 with a database configured to store sound information (that is, a sound information database), a server 22 configured to generate associated sound information for emoji packages, and a server 23 configured to provide data transmission for a plurality of terminals 10. A first terminal 11 and a second terminal 12 are used as an example. During a chat session between the first terminal 11 and the second terminal 12, when a user of the first terminal 11 switches an occurrence mode of a first emoji package to a first transmission mode, the first terminal 11 transmits an associated sound information acquisition instruction to the server 22. After receiving the associated information acquisition instruction, the server 22 performs matching for obtaining associated first sound information of the first emoji package from various sound information in the sound information database of the server 21, generates associated sound information for the first emoji package according to the first sound information, and transmits the associated sound information to the first terminal 11. When the user of the first terminal 11 transmits the first emoji package to a user of the second terminal 12, the first terminal 11 transmits a to-be-transmitted message to the server 23, and the server 23 forwards the to-be-transmitted message to the second terminal 12. The to-be-transmitted message is a message used for displaying the first emoji package and the associated sound information of the first emoji package.

The above servers 21, 22, and 23 may be the same server or different servers, which is not limited in this embodiment of this disclosure.

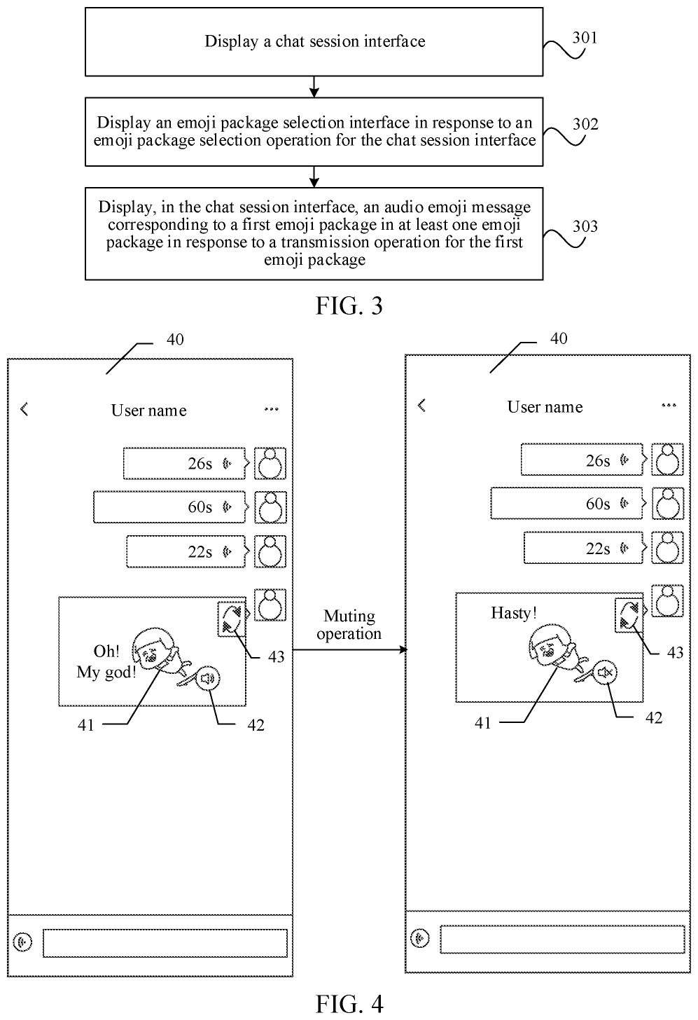

FIG. 3 is a flowchart of an emoji package display method according to an embodiment of this disclosure. The method may be applied to the terminal 10 in the emoji package display system shown in FIG. 1. For example, an execution body of each step may be the client of the application installed in the terminal 10. In an example, a method for audio-enabled messaging of an image is provided. The method may include at least one of the following steps (301-303):

In step 301, display a chat session interface. In an example, a messaging interface is displayed.

The chat session interface is configured to display chat messages between at least two users. The chat messages include but are not limited to at least one of a text message, an image message, an audio messages, or a video message. Different applications may correspond to different chat session interfaces.

In this embodiment of this disclosure, when the users transmit messages, the client displays, in the chat session interface, the messages transmitted by the users. In an example, if the chat session interface includes chat messages that have been transmitted, identification information of a sender account of the chat messages that have been transmitted is displayed in the chat session interface. The identification information includes at least one of an account name, an account avatar, or an account level.

The chat session interface may display historical chat messages between the users while displaying real-time chat messages between the users.

In an implementation, in order to display the chat messages more completely, the chat session interface includes the above historical chat messages. For example, when the client displays the above chat session interface, the client acquires the historical chat messages between the above users and displays the historical chat messages in the chat session interface. The historical chat message may be historical messages obtained in real time or historical messages pre-stored in the client.

In a implementation, in order to realize a cleaner chat session interface, the chat session interface does not include the above historical chat messages. For example, when the client displays the above chat session interface, the client does not need to acquire the historical chat messages between the above users and may directly display the chat session interface.

In step 302, display an emoji package selection interface in response to an emoji package selection operation for the chat session interface. In an example, an image selection interface is displayed in response to a first user operation via the messaging interface. The image selection interface is configured to display at least one image for selection by a user.

In this embodiment of this disclosure, the client detects the emoji package selection operation after displaying the chat session interface, and displays the emoji package selection interface when detecting the emoji package selection operation for the chat session interface. The above emoji package selection interface is an interface for displaying emoji packages for selection by users. For example, at least one emoji package is displayed in the emoji package selection interface. In addition to the emoji packages in the forms of the static image and the dynamic image mentioned above, emoji packages in other forms may be utilized, such as video emoji packages, animated emoji packages, or video animated emoji packages.

In an example, when the client displays the above emoji package selection interface, if the emoji package selection interface and the chat session interface have the same display element, display of display elements in the chat session interface is canceled and display elements in the emoji package selection interface are displayed while keeping the same display element unchanged. If the emoji package selection interface does not have the same display element as the chat session interface, the display element in the chat session interface is directly canceled and the display element in the emoji package selection interface is displayed. In this way, the impact of the chat session interface on the display and selection of emoji packages can be avoided, thereby improving the display effect of emoji packages and realizing more intuitive selection of emoji packages.

The above emoji package selection operation is an operation used for calling an emoji package selection interface.

In an implementation, the above chat session interface includes an emoji package selection control. The emoji package selection operation is a trigger operation for the emoji package selection control, and the user performs the trigger operation for the emoji package selection control to trigger the operation to cause the client to display the emoji package selection interface. The above operation may be a tapping operation, a holding and pressing operation, a sliding operation, or the like, which is not limited in this embodiment of this disclosure. The above chat session interface may further include other operation controls, such as a chat message transmission control, a historical message search control, a chat message sharing control, and the like.

In an implementation, in order to make the chat session interface cleaner, the emoji package selection operation is a particular operation for the chat session interface, that is, the emoji package selection control does not need to be displayed in the chat session interface. The user may perform a particular operation in the chat session interface to cause the client to display the emoji package selection interface. The above operation may be a particular number of tapping operations, a holding and pressing operation lasting a particular duration, a sliding operation with a particular trajectory, a pressing operation at a pressing key position, or the like, which is not limited in this embodiment of this disclosure. The user may perform other particular operations on the chat session interface, such as a chat message transmission operation, a historical message searching operation, or a chat message sharing operation.

In step 303, display, in the chat session interface, an audio emoji message corresponding to a first emoji package in the at least one emoji package in response to a transmission operation for the first emoji package. In an example, an audio-enabled message that includes an image that is selected from the at least one image by the user is displayed in the messaging interface. The audio-enabled message includes the selected image and audio information that is determined to be associated with the selected image.

In an example, the above emoji package selection interface includes an emoji package option, and different emoji packages correspond to different options. The option may be the emoji package, or may be a thumbnail, a cover image, a name, or the like of the emoji package, which is not limited in this embodiment of this disclosure. The user nay trigger different operations for the emoji package by performing different operations on the option. For example, the option is tapped to trigger a transmission operation for the emoji package corresponding to the option. The option is held and pressed to trigger a selection operation for the emoji package corresponding to the option. The option is dragged to trigger a location movement operation for the emoji package corresponding to the option.

In this embodiment of this disclosure, the client detects the above emoji package selection interface after displaying the emoji package selection interface, and displays, in the chat session interface, the audio emoji message corresponding to the first emoji package when detecting the transmission operation for the first emoji package in the at least one emoji package.

The first emoji package may be any of the at least one emoji package. In this embodiment of this disclosure, the audio emoji message corresponding to the first emoji package is used for displaying the first emoji package and associated sound information of the first emoji package, the associated sound information of the first emoji package is sound information associated with the first emoji package obtained by matching from a sound information database. The sound information database pre-stores a plurality of pieces of sound information.

In an implementation, the audio emoji message includes the first emoji package and a sound playback control configured to play the associated sound information of the first emoji package. For example, when detecting the transmission operation for the first emoji package, the client transmits the first emoji package and the associated sound information of the first emoji package to a receiver account, and displays, in the chat session interface, the first emoji package and the sound playback control corresponding to the first emoji package. Exemplarily, as shown in FIG. 4, after the audio emoji message corresponding to the first emoji package is transmitted, a first emoji package 41 and a sound playback control 42 are displayed in a chat session interface 40. By providing the sound playback control, the user may play or not play associated sound information as required, thereby improving the user experience.

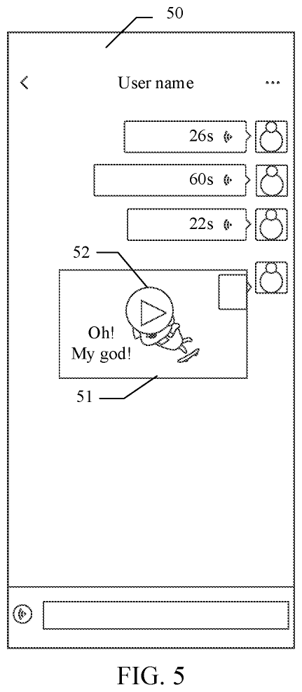

In an implementation, the above audio emoji message includes an audio video of the first emoji package. For example, when detecting the transmission operation for the first emoji package, the client generates the audio video of the first emoji package according to the first emoji package and the associated sound information of the first emoji package, transmits the audio video to the receiver account, and displays the audio video of the first emoji package in the chat session interface. The above audio emoji message may further include a video playback control configured to play the audio video. Exemplarily, as shown in FIG. 5, after the audio emoji message corresponding to the first emoji package is transmitted, an audio video 51 of the first emoji package and a video playback control 52 are displayed in a chat session interface 50. In this way, the emoji package is not limited to the image display form, thereby enriching the display diversity of emoji packages and further improving the user experience.

The above audio emoji message may further include subtitle information. In an implementation, the subtitle information is text information in the first emoji package. The text information may be a text set by a creator of the first emoji package in the first emoji package, or may be a text inputted by a sender account of the audio emoji message, which is not limited in this embodiment of this disclosure. In an implementation, the subtitle information is a label of the first emoji package, and feature information of the first emoji package may be obtained based on the label. The label may be set by the creator of the first emoji package or inputted by the sender account of the audio emoji message, which is not limited in this embodiment of this disclosure. The label may alternatively be referred to as an identifier, a description, a definition, or the like.

In an example, when the client transmits the above audio emoji message, the client may directly transmit the first emoji package and the associated sound information to a corresponding device. Alternatively, the client may transmit identification information of the first emoji package and the associated sound information to the corresponding device, and then the device may acquire the associated sound information according to the identification information of the associated sound information and generate the above audio emoji message. The above device may be a terminal where the receiver account is located, or may be a message transit server, which is not limited in this embodiment of this disclosure.

Accordingly, in a technical solution provided in this embodiment of this disclosure, the first emoji package and the associated sound information of the first emoji package are displayed through the audio emoji message corresponding to the first emoji package. That is to say, when users transmit the first emoji package, they can communicate through both the first emoji package and the associated sound information of the first emoji package, so that the communication based on the emoji packages is not restricted to communication through images, and the communication through emoji packages becomes more diverse, thereby providing users with more desirable chat atmosphere. Moreover, the associated sound information of the first emoji package is the sound information associated with the first emoji package obtained by matching from the sound information database. That is to say, the audio emoji message corresponding to the first emoji package may be generated by matching with existing sound information without a need to record the first emoji package in advance or in real time, which reduces the acquisition overheads and time costs of the associated sound information, thereby reducing the generation overheads and time costs of the audio emoji message. The sound information in the sound information database is applicable to a plurality of emoji packages. Therefore, the audio emoji messages respectively corresponding to the plurality of emoji packages may be acquired without a need to record the emoji packages one by one, which can effectively improve the efficiency of generating audio emoji messages in the case of a large number of emoji packages.

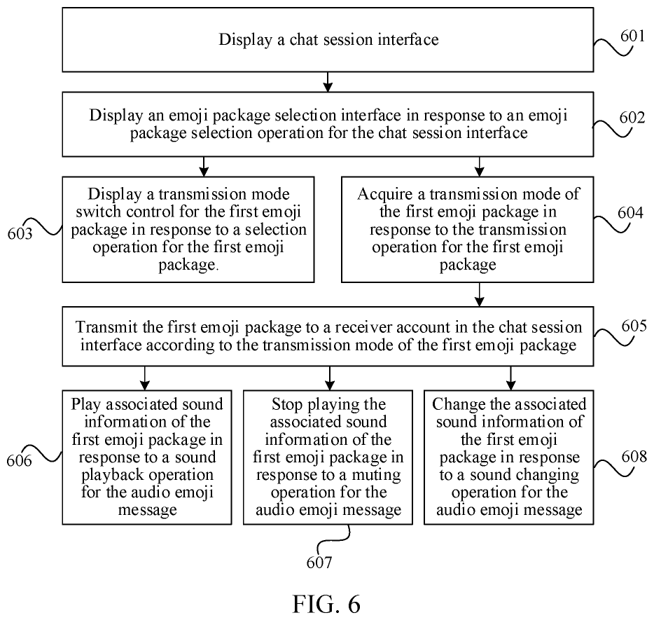

FIG. 6 is a flowchart of an emoji package display method according to an embodiment of this disclosure. The method may be applied to the terminal 10 in the emoji package display system shown in FIG. 1. For example, an execution body of each step may be the client of the application installed in the terminal 10. The method may include at least one of the following steps (601-608):

In step 601, display a chat session interface.

In step 602, display an emoji package selection interface in response to an emoji package selection operation for the chat session interface.

The above steps 601 and 602 may be the same as steps 301 and 302 in the embodiment of FIG. 3. For an exemplary implementation, reference may be made to the embodiment of FIG. 3.

In step 603, display a transmission mode switch control for the first emoji package in response to a selection operation for the first emoji package. In an example, a messaging mode switch control element is displayed.

In this embodiment of this disclosure, the client detects the above selection operation after displaying the emoji package selection interface, and displays the transmission mode switch control for the first emoji package when detecting the selection operation for the first emoji package. In an example, the above emoji package selection interface includes an emoji package option, and different emoji packages correspond to different options. The user triggers the selection operation for the first emoji package through the option of the first emoji package.

The above transmission mode switch control is configured to control the switching of the transmission mode of the first emoji package. In this embodiment of this disclosure, the client detects an operation on the transmission mode switch control after displaying the transmission mode switch control, and switches the transmission mode of the first emoji package after receiving the operation for the transmission mode switch control. In an example, if the transmission mode of the first emoji package is a second transmission mode, the client controls the transmission mode to switch from the second transmission mode to a first transmission mode after receiving the operation for the transmission mode switch control. If the transmission mode of the first emoji package is the first transmission mode, the client controls the transmission mode to switch from the first transmission mode to the second transmission mode after receiving the operation for the transmission mode switch control. The first transmission mode means transmitting the first emoji package in the form of the audio emoji message, and the second transmission mode means transmitting the first emoji package in the form of the first emoji package.

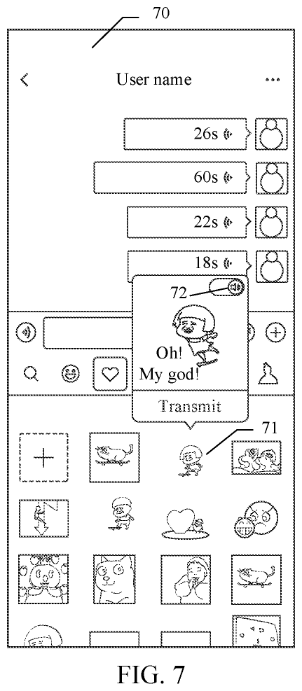

Exemplarily, as shown in FIG. 7, an emoji package selection interface 70 includes a plurality of emoji package options. The user triggers the selection operation for the first emoji package by holding and pressing a selection option 71 of the first emoji package, and then the emoji package selection interface 70 displays a transmission mode switch control 72 for the first emoji package. Further, the user may switch the transmission mode (or messaging mode) of the first emoji package through the transmission mode switch control 72.

In this embodiment of this disclosure, the transmission mode switch control is provided so that the user can flexibly set the transmission mode of the first emoji package as required, thereby improving the transmission flexibility of emoji packages.

In step 604, acquire a transmission mode of the first emoji package in response to the transmission operation for the first emoji package.

In this embodiment of this disclosure, the client detects an operation on the above emoji package selection interface after displaying the emoji package selection interface, and acquires the transmission mode of the first emoji package when detecting the transmission operation for the first emoji package. In an example, the user triggers the transmission operation for the first emoji package through the option of the first emoji package.

In step 605, transmit the first emoji package to a receiver account in the chat session interface according to the transmission mode of the first emoji package.

In this embodiment of this disclosure, after acquiring the transmission mode, the client transmits the first emoji package to the receiver account in the chat session interface according to the transmission mode.

In an example, if the transmission mode is the first transmission mode, the client transmits the audio emoji message corresponding to the first emoji package to the receiver account in the chat session interface, and displays, in the chat session interface, the audio emoji message corresponding to the first emoji package. If the transmission mode is the second transmission mode, the client only transmits the first emoji package to the receiver account in the chat session interface, and displays the first emoji package in the chat session interface. The client can transmit the emoji package through either the first transmission mode or the second transmission mode, so that the transmission flexibility of emoji packages is further improved.

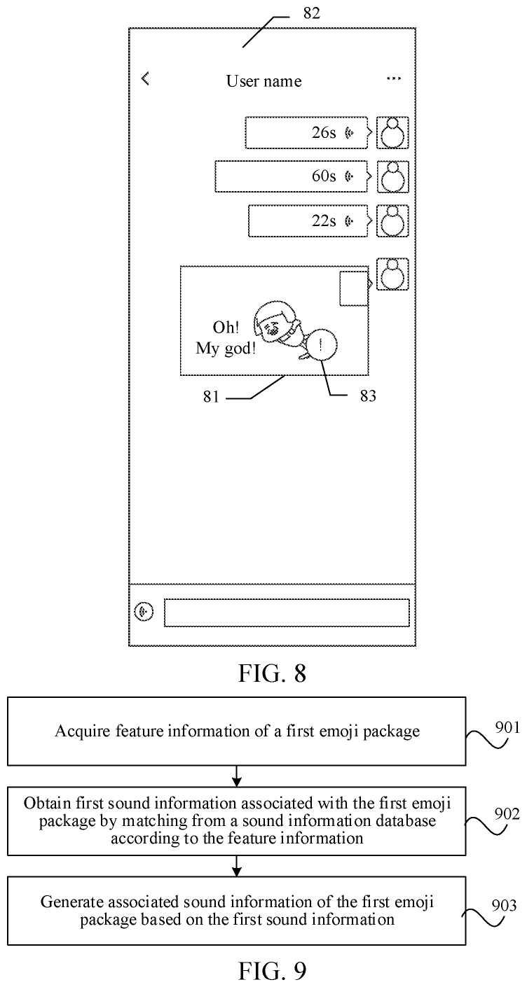

In an example, in a case that the transmission mode is the first transmission mode, if the first emoji package matches no associated sound information, the client transmits a silent emoji message corresponding to the first emoji package to the receiver account in the chat session interface, and displays, in the chat session interface, the silent emoji message corresponding to the first emoji package. The silent emoji message includes the first emoji package and a sound matching failure identifier. Exemplarily, as shown in FIG. 8, in case that a first emoji package 81 matches no associated sound information, the first emoji package 81 and a sound matching failure identifier 83 are displayed in a chat session interface 82.

In an example, after the above audio emoji message is displayed on the chat session interface, the user may control the playback, pause, or replacement of the associated sound information according to an actual situation.

In step 606, play the associated sound information of the first emoji package in response to a sound playback operation for the audio emoji message.

In this embodiment of this disclosure, the client detects the audio emoji message after displaying the audio emoji message, and plays the associated sound information of the first emoji package after detecting the sound playback operation for the audio emoji message. The sound playback operation may be specific to a first particular control, or may be specific to a first particular operation for the audio emoji message, which is not limited in this embodiment of this disclosure. Exemplarily, the user triggers the sound playback operation by tapping the sound playback control 42 in FIG. 4 to play the associated sound information of the first emoji package. Alternatively, the user triggers the sound playback operation by clicking on the video playback control 52 in FIG. 5 to play the associated sound information of the first emoji package.

In an example, if the first emoji package is a video animation composed of a plurality of images, the client plays the video animation of the first emoji package while playing the associated sound information when detecting the sound playback operation for the audio emoji message.

In step 607, stop playing the associated sound information of the first emoji package in response to a muting operation for the audio emoji message.

In this embodiment of this disclosure, the client detects the audio emoji message after displaying the audio emoji message, and stops playing the associated sound information of the first emoji package after detecting the muting operation for the audio emoji message. The muting operation may be specific to a second particular control, or may be specific to a second particular operation for the audio emoji message, which is not limited in this embodiment of this disclosure.

In an example, the above first particular control and second particular control may be the same operation control or different operation controls, which is not limited in this embodiment of this disclosure. For example, if the above first particular control and second particular control are the same operation control, the above sound playback operation and muting operation are different operations for the same operation control. Exemplarily, the user triggers the muting operation through double-tapping of the sound playback control 42 in FIG. 4 to stop playing the associated sound information of the first emoji package. Moreover, after the user triggers the muting operation, the display style of the sound playback control 42 changes.

In an example, if the first emoji package is a video animation composed of a plurality of images, the client stops playing the associated sound information but may still play the video animation of the first emoji package when detecting the muting operation for the audio emoji message.

In step 608, change the associated sound information of the first emoji package in response to a sound changing operation for the audio emoji message.

In this embodiment of this disclosure, the client detects the audio emoji message after displaying the audio emoji message, and changes the associated sound information of the first emoji package after detecting the sound changing operation for the audio emoji message. The sound changing operation may be specific to a third particular control, or may be specific to a third particular operation for the audio emoji message, which is not limited in this embodiment of this disclosure. Exemplarily, as shown in FIG. 4, a sound changing control 43 is displayed in the chat session interface 40. The user taps the sound changing control 43 to change the associated sound information of the first emoji package.

In an example, the above first particular control, second particular control, and third particular control may be the same operation control or different operation controls, which is not limited in this embodiment of this disclosure. For example, if the above first particular control, second particular control, and third particular control are the same operation control, the above sound playback operation, muting operation, and sound changing operation are different operations for the same operation control.

When changing the associated sound information of the first emoji package, the client may automatically change the associated sound information, or may change the associated sound information based on a selection of the user.

In an implementation, the client automatically changes the associated sound information. For example, after detecting the above sound changing operation, the client selects candidate sound information satisfying a first condition from at least one piece of candidate sound information to generate replacement sound information for the first emoji package, and replaces the associated sound information of the first emoji package with the replacement sound information for the first emoji package. The candidate sound information is obtained by matching according to feature information of the first emoji package and a label corresponding to each piece of sound information in the sound information database. The above first condition is a selection condition for the candidate sound information. For example, this first condition is candidate sound information with the highest degree of matching with the feature information of the first emoji package. In an exemplary embodiment, replacement sound information may be randomly selected from the at least one piece of candidate sound information for the first emoji package.

In an implementation, the client changes the associated sound information based on a selection of the user. For example, after detecting the above sound changing operation, the client displays the at least one piece of candidate sound information and detects each piece of the candidate sound information, and generates replacement sound information for the first emoji package according to target sound information in the at least one piece of candidate sound information in a case that a selection operation for the target sound information is detected, and replaces the associated sound information of the first emoji package with the replacement sound information for the first emoji package.

The above candidate sound information does not include the associated sound information and historical associated sound information of the first emoji package. The historical associated sound information is sound information that was associated sound information of the first emoji package.

After the associated sound information of the first emoji package changes, the changed associated sound information or identification information of the changed associated sound information needs to be synchronized to the above receiver account.

Accordingly, in a technical solution provided in this embodiment of this disclosure, the audio emoji message corresponding to the first emoji package is transmitted to the receiver account in the chat session interface during transmission of the first emoji package only when the transmission mode of the first emoji package is the first transmission mode. The transmission mode may be flexibly switched through the transmission mode switch control. Users may flexibly set the transmission mode of the first emoji package according to an actual situation, so that the communication through the first emoji package can satisfy the needs of different users.

In addition, through the sound changing operation, the associated sound information of the first emoji package can be changed. The associated sound information may be flexibly changed with reference to a suggestion of the user during the acquisition of the associated sound information of the first emoji package, which improves the accuracy of the acquired associated sound information.

In addition, since the user selects the associated sound information of the first emoji package from the candidate sound information, the accuracy of the associated sound information is improved, the connection between and the associated sound information and the first emoji package is enhanced, so that the audio emoji message can express a wish of the user more effectively.

FIG. 9 is a flowchart of a method for acquiring an associated sound of an emoji package according to an embodiment of this disclosure. The method may be applied to the terminal 10 of the emoji package display system shown in FIG. 1, or may be applied to the server 20 of the emoji package display system shown in FIG. 1, or may be implemented through interaction between the terminal 10 and the server 20, which is not limited in this embodiment of this disclosure (execution bodies of the method for acquiring an associated sound of an emoji package are collectively referred to as a “server”). In an example, a method for obtaining audio information for an audio-enabled message is provided. The method may include at least one of the following steps (901-903):

In step 901, acquire feature information of a first emoji package. In an example, feature information of an image to be included in the audio-enabled message is obtained.

The first emoji package is an emoji package for which sound information is to be matched, which may be any of a plurality of emoji packages provided by an application. In this embodiment of this disclosure, the server acquires feature information of the first emoji package before matching the sound information for the first emoji package.

The feature information may be generated in real time or pre-generated, which is not limited in this embodiment of this disclosure.

In an implementation, the feature information is generated in real time. For example, when determining to perform the sound information matching for the first emoji package, the server generates the feature information of the first emoji package in real time.

In an implementation, the feature information is pre-generated. For example, upon acquisition of the first emoji package, the server generates the feature information of the first emoji package and stores the feature information. Therefore, when determining to perform the sound information matching for the first emoji package, the server directly acquires the feature information from a storage location of the feature information.

In an example, the feature information includes but is not limited to at least one of text feature information, scenario feature information, or emotion feature information. The text feature information is used for indicating a text included in the first emoji package. The scenario feature information is used for indicating an exemplary usage scenario of the first emoji package. For example, scenario feature information of a goodnight emoji package may be before going to bed at night. The emotion feature information is used for indicating an emotion of a user when using the first emoji package. For example, if the emoji package includes words “So hard”, the emotion feature information may be anxiety and sadness.

In an exemplary implementation, the feature information includes the text feature information. For example, during acquisition of the feature information of the first emoji package, the server performs text extraction on text information in the first emoji package to obtain text feature information of the first emoji package. the text information in the first emoji package may include at least one of a text in the first emoji package or an input text for the first emoji package. The text in the first emoji package is a text pre-stored in the first emoji package, and the input text for the first emoji package is a text inputted for the first emoji package. In an embodiment, in the presence of the input text, the text in the first emoji package may be ignored.

In an implementation, the feature information includes the scenario feature information. For example, during acquisition of the feature information of the first emoji package, the server performs feature extraction on the first emoji package, an associated chat message of the first emoji package, and an associated chat scenario of the first emoji package to obtain scenario feature information of the first emoji package. The associated chat message of the first emoji package is a historical chat message of which a time difference between a transmission time and a current time is less than a threshold. The associated chat scenario of the first emoji package is used for indicating a current chat time and at least one current chat account. In an embodiment, a number of associated chat messages may be preset or not set, which is not limited in this implementation of this disclosure. The current chat account may be understood as the above receiver account for example.

In an implementation, the feature information includes the above emotion feature information. For example, during acquisition of the feature information of the first emoji package, the server performs feature extraction on the first emoji package and an associated chat message of the first emoji package to obtain emotion feature information of the first emoji package.

The first emoji package may be any emoji package or an emoji package that satisfies a particular requirement. For example, in order to improve the accuracy of feature information acquisition, the particular requirement may be an emoji package from which a text may be extracted.

In this embodiment of this disclosure, the feature information of the emoji package is set to include but not limited to at least one of the text feature information, the scenario feature information, or the emotion feature information, so that the emoji package can be more accurately represented through the feature information, thereby improving the matching accuracy of first sound information.

In step 902, obtain first sound information associated with the first emoji package by matching from a sound information database according to the feature information. In an example, audio information that is determined to be associated with the image is obtained according to the feature information.

In this embodiment of this disclosure, after acquiring the above feature information, the server obtains the first sound information associated with the first emoji package by matching from the sound information database according to the feature information. The sound information database pre-stores a plurality of pieces of sound information.

In an implementation, the plurality of pieces of sound information stored in the sound information database is historical sound information from the sender account of the first emoji package.

In an implementation, the plurality of pieces of sound information stored in the sound information database is historical sound information from different accounts.

The historical sound information may be generated during a chat session or in a recording scenario, which is not limited in this embodiment of this disclosure.

In step 903, generate associated sound information of the first emoji package based on the first sound information. In an example, associated audio information of the image to be included in the audio-enabled message with the image is generated based on the obtained audio information.

In this embodiment of this disclosure, after acquiring the first sound information, the server generates the associated sound information of the first emoji package based on the first sound information. The associated sound information of the first emoji package is used for generating an audio emoji message corresponding to the first emoji package.

The server may directly use the first sound information as the associated sound information, or edit the first sound information to obtain the associated sound information.

In an implementation, the server directly uses the first sound information as the associated sound information. For example, after acquiring the first sound information, the server acquires the text information included in the first emoji package and compares the text information included in the first sound information with the text information included in the first emoji package. In a case that the text information included in the first emoji package is the entirety of the text information included in the first sound information, the first sound information is directly used as the associated sound information.

In an implementation, the server edits the first sound information to obtain the associated sound information. For example, after acquiring the first sound information, the server acquires the text information included in the first emoji package and compares the text information included in the first sound information with the text information included in the first emoji package. In a case that the text information included in the first emoji package is a part of the text information included in the first sound information, a sound clip including the text information included in the first emoji package is intercepted from the first sound information according to the text information included in the first emoji package, and the associated sound information of the first emoji package is generated based on the sound clip. By acquiring the sound clip through the text information, the degree of matching between the sound clip and the emoji package can be improved, thereby improving the accuracy and reasonability of sound clip acquisition.

After acquiring the sound clip, the server may use the sound clip as the associated sound information, or edit the sound clip to obtain the associated sound information.

In an implementation, the server directly uses the sound clip as the associated sound information. For example, after acquiring the sound clip, the server directly uses the sound clip as the associated sound information if the first emoji package is a single image.

In an implementation, the server edits the sound clip to obtain the associated sound information. For example, after acquiring the sound clip, the server adjusts a playback duration of the sound clip based on a playback duration of the first emoji package in a case that the first emoji package is a video animation, to obtain the associated sound information of the first emoji package, a playback duration of the associated sound information of the first emoji package being the same as the playback duration of the first emoji package. The server may adjust the playback duration of the sound clip by adjusting a sound playback frequency. In a case that the emoji package is the video animation, it is ensured that the playback duration of the associated sound information of the emoji package is the same as the playback duration of the emoji package, so that the associated sound information matches the emoji package to a larger degree, thereby improving the display effect of the emoji package.

Accordingly, in a technical solution provided in this embodiment of this disclosure, the first sound information associated with the first emoji package is obtained by matching through the feature information of the first emoji package, which improves the degree of matching between the first sound information and the first emoji package, thereby realizing high accuracy of the associated sound information subsequently generated based on the first sound information. Moreover, the associated sound information of the first emoji package may be generated through the existing sound information in the sound information database, without a need of special dubbing and recording for the first sound information. In addition, the sound information in the sound information database is applicable to a plurality of emoji packages, so that the associated sound information corresponding to the plurality of emoji packages may be acquired without a need of dubbing and recording for the emoji packages one by one, which improves the efficiency of generating the associated sound information, and reduces the generation overheads and time costs of the associated sound information.

An example of acquiring the first sound information is described below.

In an exemplary embodiment, step 902 includes the following steps:

1. Acquire a label corresponding to each piece of sound information in the sound information database.

In this embodiment of this disclosure, during the first sound information matching for the first emoji package, the server acquires the label corresponding to each piece of sound information in the sound information database.

The label may be generated in real time or pre-generated, which is not limited in this embodiment of this disclosure.

In an implementation, the label is generated in real time. For example, when determining to perform the sound information matching for the first emoji package, the server acquires each piece of sound information in the sound information database, and generates the label corresponding to each piece of sound information.

In an implementation, the label is pre-generated. For example, upon acquisition of the sound information, the server generates the label of the sound information and stores the label of the sound information. Therefore, when determining to perform the sound information matching for the first emoji package, the server directly acquires the label of the sound information from a storage location of the label of the sound information.

In an implementation, in the above labels, some sound information labels are generated in real time, and some sound information labels are pre-generated. For example, during the sound information matching for the first emoji package, the server acquires each piece of sound information in the sound information database, detects whether the sound information has a label, and generates, for the sound information without a label, a label in real time and stores the label at a corresponding location for future use.

In an example, the label includes but is not limited to at least one of a text label, a scenario label, or an emotion label. The text label is used for indicating a text corresponding to the sound information. The scenario label is used for indicating a transmission scenario corresponding to the sound information. For example, the scenario label is: transmit to the target user in the first chat group at 20:11. The emotion label is used for indicating an emotion corresponding to the sound information, that is, an emotion included in the sound information.

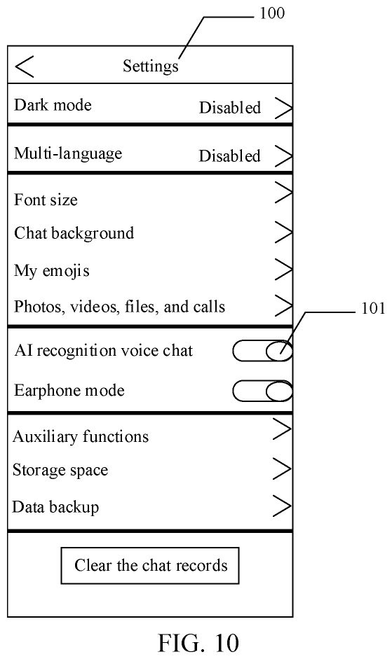

The user may autonomously set whether to allow the server to collect historical sound information thereof and store the historical sound information in the sound information database according to an actual situation. Exemplarily, as shown in FIG. 10, a function setting interface 100 includes a voice recognition switch 101. The user controls the enabling and disabling of a historical sound information collection function through the voice recognition switch 101.

The sender account of the first emoji package is used as an example. After the historical sound information collection function is enabled, the server collects a plurality of pieces of historical sound information transmitted by the sender account of the first emoji package. Further, text conversion is performed on a sound included in each piece of the historical sound information to obtain a text label corresponding to each piece of the historical sound information, a scenario label corresponding to each piece of the historical sound information is obtained based on a transmission scenario corresponding to each piece of the historical sound information, and an emotion label corresponding to each piece of the historical sound information is obtained based on a sound emotion corresponding to each piece of the historical sound information.

In an implementation, the server collects a plurality of pieces of historical sound information transmitted by the sender account of the first emoji package in a target time period during the collection of the plurality of pieces of historical sound information transmitted by the sender account. The target time period may be a time period formed by time moments that have a difference less than a target value from a current time moment, or may be a time period in which messages are frequently transmitted, which is not limited in this implementation of this disclosure. Different sender accounts may correspond to different target time periods.

In an implementation, the server collects a plurality of pieces of historical sound information transmitted by the sender account of the first emoji package and having a total playback duration less than a threshold during the collection of the plurality of pieces of historical sound information transmitted by the sender account. The threshold may be any numerical value, such as 10s, 7s, 5s, or 2s, which is not limited in this implementation of this disclosure.

In this embodiment of this disclosure, the sound information database is constructed based on the historical sound information transmitted by the sender account, and is used as the associated sound information corresponding to the emoji package transmitted by the sender account, so that the audio emoji message corresponding to the emoji package is more in line with the chat style of the sender account, thereby further improving the user chat experience.

2. Select, from the sound information database and according to the label corresponding to each piece of sound information, at least one piece of candidate sound information matching the feature information.

In this embodiment of this disclosure, after acquiring the label corresponding to each piece of sound information, the server selects, from the sound information database and according to the label corresponding to each piece of sound information, the at least one piece of candidate sound information matching the feature information.

In an example, if the feature information includes the text feature information, and the label includes the text label, the server selects, from the sound information database and according to the text feature information in the feature information and the text label corresponding to each piece of sound information, the at least one piece of candidate sound information matching the text feature information.

In an example, if the feature information includes the scenario feature information, and the label includes the scenario label, the server selects, from the sound information database and according to the scenario feature information in the feature information and the scenario label corresponding to each piece of sound information, the at least one piece of candidate sound information matching the scenario feature information.

In an example, if the feature information includes the emotion feature information, and the label includes the emotion label, the server selects, from the sound information database and according to the emotion feature information in the feature information and the emotion label corresponding to each piece of sound information, the at least one piece of candidate sound information matching the emotion feature information.

In this embodiment of this disclosure, a plurality of candidate sound information selection methods are provided, such as text feature matching, scenario feature matching, and emotion feature matching, so that the server can obtain more comprehensive candidate sound information, thereby improving the acquisition reasonableness of the first sound information.

3. Select, from the at least one piece of candidate sound information, candidate sound information satisfying a second condition as the first sound information.

In this embodiment of this disclosure, after acquiring the at least one piece of candidate sound information, the server selects the candidate sound information satisfying the second condition from the at least one piece of candidate sound information as the first sound information.

The second condition is the selection condition for the candidate sound information. For example, the second condition is candidate sound information with the highest degree of matching with the feature information of the first emoji package. That is to say, during the acquisition of the first sound information, the server selects the sound information with the highest degree of matching with the feature information from the candidate sound information as the first sound information. In an exemplary embodiment, the server may randomly select the first sound information for the first emoji package from the at least one piece of candidate sound information, to ensure that the first sound information can be matched for the first emoji package when the matching degrees of the candidate sound information are the same.

In this embodiment of this disclosure, the first sound information is selected from the plurality of pieces of candidate sound information associated with the emoji package obtained by matching according to the feature information of the emoji package and the label corresponding to the sound information, so that the degree of matching between the first sound information and the emoji package is higher, thereby improving the accuracy of the associated sound information generated based on the first sound information.

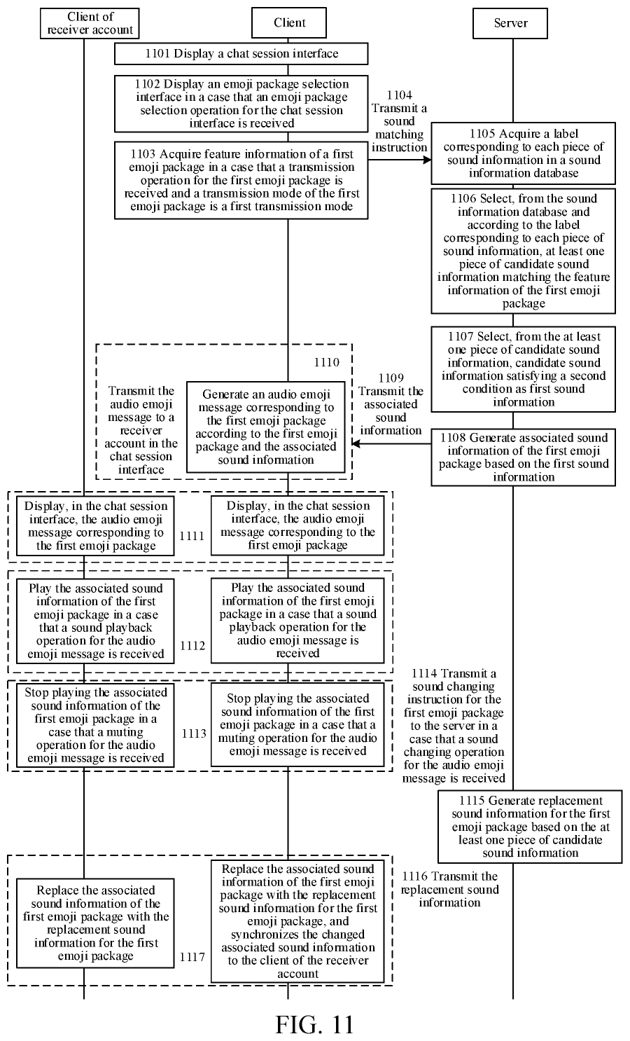

In addition, with reference to FIG. 11, an exemplary solution of this disclosure is described from the perspective of interaction between the client and the server. Exemplary steps include at least one of the following steps:

In step 1101, the client displays a chat session interface.

In step 1102, the client displays an emoji package selection interface in a case that an emoji package selection operation for the chat session interface is received. At least one emoji package is displayed in the emoji package selection interface.

In step 1103, the client acquires feature information of a first emoji package in a case that a transmission operation for the first emoji package is received and a transmission mode of the first emoji package is a first transmission mode.

In step 1104, the client transmits a sound matching instruction to the server. The sound matching instruction includes the feature information of the first emoji package.

In step 1105, the server acquires a label corresponding to each piece of sound information in a sound information database.

In step 1106, the server selects, from the sound information database and according to the label corresponding to each piece of sound information, at least one piece of candidate sound information matching the feature information of the first emoji package.

In step 1107, the server selects, from the at least one piece of candidate sound information, candidate sound information satisfying a second condition as first sound information.

In step 1108, the server generates associated sound information of the first emoji package based on the first sound information.

In step 1109, the server transmits the associated sound information to the client.

In step 1110, the client generates an audio emoji message corresponding to the first emoji package according to the first emoji package and the associated sound information, and transmits the audio emoji message to a receiver account in the chat session interface.

In step 1111, the client displays, in the chat session interface, the audio emoji message corresponding to the first emoji package. A client of the receiver account also displays, in the chat session interface, the audio emoji message corresponding to the first emoji package.

In step 1112, the client plays the associated sound information of the first emoji package in a case that a sound playback operation for the audio emoji message is received. The client of the receiver account also plays the associated sound information of the first emoji package in a case that the sound playback operation for the audio emoji message is received.

In step 1113, the client stops playing the associated sound information of the first emoji package in a case that a muting operation for the audio emoji message is received. The client of the receiver account also stops playing the associated sound information of the first emoji package in a case that the muting operation for the audio emoji message is received.

In step 1114, the client transmits a sound changing instruction for the first emoji package to the server in a case that a sound changing operation for the audio emoji message is received.

In step 1115, the server generates replacement sound information for the first emoji package based on the at least one piece of candidate sound information.

In step 1116, the server transmits replacement sound information to the client.

In step 1117, the client replaces the associated sound information of the first emoji package with the replacement sound information for the first emoji package, and synchronizes the changed associated sound information to the client of the receiver account. The client of the receiver account also replaces the associated sound information of the first emoji package with the replacement sound information for the first emoji package.

The above description of this disclosure through the embodiments is merely illustrative and explanatory. Other embodiments formed by any combination of the steps in the above embodiments also falls within the scope of this disclosure.

Apparatus embodiments of this disclosure are described below, which may be used for performing the method embodiments of this disclosure. For details not disclosed in the apparatus embodiments of this disclosure, reference may be made to the above exemplary embodiments of this disclosure.

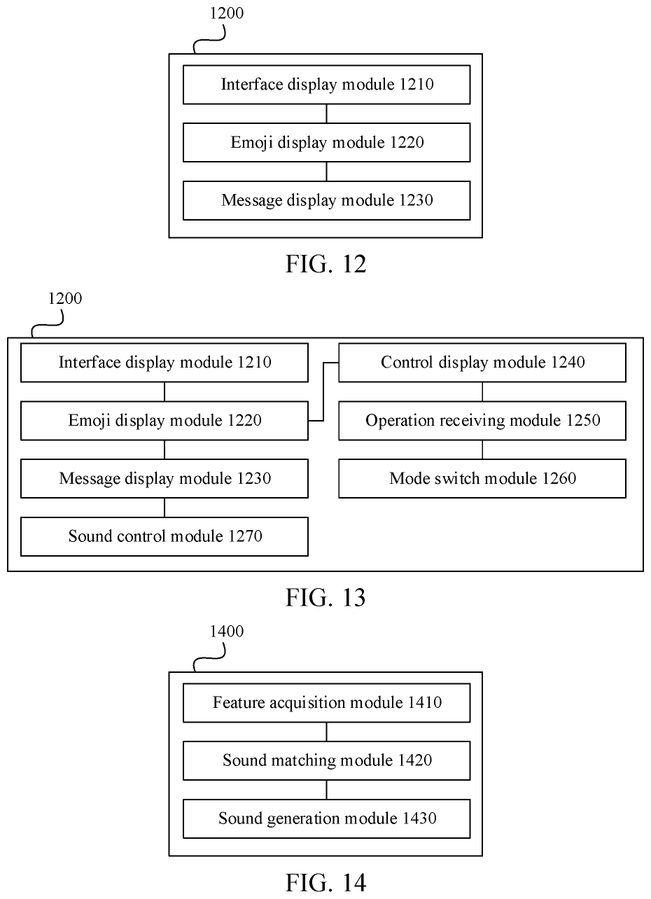

FIG. 12 is a block diagram of an emoji package display apparatus according to an embodiment of this disclosure. The apparatus has a function of realizing the above emoji package display method, and the function may be realized by hardware or by hardware executing corresponding software, such as processing circuitry. The apparatus may be a terminal device, or may be disposed in the terminal device. The apparatus 1200 may include an interface display module 1210, an emoji display module 1220, and a message display module 1230.

The interface display module 1210 is configured to display a chat session interface, the chat session interface being configured to display chat messages between at least two users.

The emoji display module 1220 is configured to display an emoji package selection interface in response to an emoji package selection operation for the chat session interface, the emoji package selection interface displaying at least one emoji package.

The message display module 1230 is configured to display, in the chat session interface, an audio emoji message corresponding to a first emoji package in the at least one emoji package in response to a transmission operation for the first emoji package, the audio emoji message corresponding to the first emoji package being used for displaying the first emoji package and associated sound information of the first emoji package, the associated sound information of the first emoji package being sound information associated with the first emoji package obtained by matching from a sound information database.

In an exemplary embodiment, the message display module 1230 is configured to: acquire a transmission mode of the first emoji package in response to the transmission operation for the first emoji package; and transmit the audio emoji message corresponding to the first emoji package to a receiver account in the chat session interface, and display, in the chat session interface, the audio emoji message corresponding to the first emoji package in a case that the transmission mode is a first transmission mode.

In an embodiment, as shown in FIG. 13, the apparatus 1200 further includes a control display module 1240, an operation receiving module 1250, and a mode switch module 1260.

The control display module 1240 is configured to display a transmission mode switch control for the first emoji package in response to a selection operation for the first emoji package.

The operation receiving module 1250 is configured to receive an operation for the transmission mode switch control.

The mode switch module 1260 is configured to control the transmission mode to switch from a second transmission mode to the first transmission mode in a case that the transmission mode of the first emoji package is the second transmission mode; and control the transmission mode to switch from the first transmission mode to the second transmission mode in a case that the transmission mode of the first emoji package is the first transmission mode.

In an embodiment, as shown in FIG. 13, the apparatus 1200 further includes a sound control module 1270.

The sound control module 1270 is configured to: play the associated sound information of the first emoji package in response to a sound playback operation for the audio emoji message; or stop playing the associated sound information of the first emoji package in response to a muting operation for the audio emoji message; or change the associated sound information of the first emoji package in response to a sound changing operation for the audio emoji message.

In an exemplary embodiment, the sound control module 1270 is configured to select candidate sound information satisfying a first condition from at least one piece of candidate sound information to generate replacement sound information for the first emoji package, the candidate sound information being obtained by matching according to feature information of the first emoji package and a label corresponding to each piece of sound information in the sound information database; and replace the associated sound information of the first emoji package with the replacement sound information for the first emoji package.

In an exemplary embodiment, the sound control module 1270 is configured to: display at least one piece of candidate sound information; generate replacement sound information for the first emoji package according to target sound information in the at least one piece of candidate sound information in response to a selection operation for the target sound information; and replace the associated sound information of the first emoji package with the replacement sound information for the first emoji package.

In an exemplary embodiment, the audio emoji message includes the first emoji package and a sound playback control configured to play the associated sound information of the first emoji package; or the audio emoji message includes an audio video of the first emoji package and a video playback control configured to play the audio video.

Accordingly, in a technical solution provided in this embodiment of this disclosure, the first emoji package and the associated sound information of the first emoji package are displayed through the audio emoji message corresponding to the first emoji package. That is to say, when users transmit the first emoji package, they can communicate through both the first emoji package and the associated sound information of the first emoji package, so that the communication based on the emoji packages is not restricted to communication through images, and the communication through emoji packages becomes more diverse, thereby providing users with more desirable chat atmosphere. Moreover, the associated sound information of the first emoji package is the sound information associated with the first emoji package obtained by matching from the sound information database. That is to say, the audio emoji message corresponding to the first emoji package may be generated by matching with existing sound information without a need to record the first emoji package in advance or in real time, which reduces the acquisition overheads and time costs of the associated sound information, thereby reducing the generation overheads and time costs of the audio emoji message. The sound information in the sound information database is applicable to a plurality of emoji packages. Therefore, the audio emoji messages respectively corresponding to the plurality of emoji packages may be acquired without a need to record the emoji packages one by one, which can effectively improve the efficiency of generating audio emoji messages in the case of a large number of emoji packages.

FIG. 14 is a block diagram of an apparatus for acquiring an associated sound of an emoji package according to an embodiment of this disclosure. The apparatus has a function of realizing the above method for acquiring an associated sound of an emoji package, and the function may be realized by hardware or by hardware executing corresponding software. The apparatus may be a server, or may be disposed in the server. The apparatus 1400 may include a feature acquisition module 1410, a sound matching module 1420, and a sound generation module 1430.

The feature acquisition module 1410 is configured to acquire feature information of a first emoji package.

The sound matching module 1420 is configured to obtain first sound information associated with the first emoji package by matching from a sound information database according to the feature information.

The sound generation module 1430 is configured to generate associated sound information of the first emoji package based on the first sound information, the associated sound information of the first emoji package being used for generating an audio emoji message corresponding to the first emoji package.

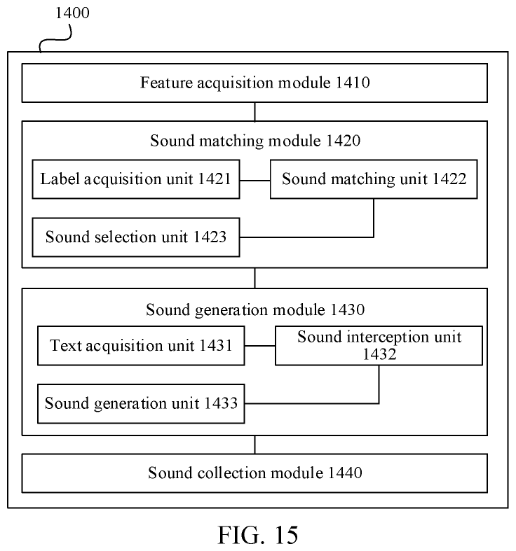

In an exemplary embodiment, as shown in FIG. 15, the sound matching module 1420 includes a label acquisition unit 1421, a sound matching unit 1422, and a sound selection unit 1423.

The label acquisition unit 1421 is configured to acquire a label corresponding to each piece of sound information in the sound information database.

The sound matching unit 1422 is configured to select, from the sound information database and according to the label corresponding to each piece of sound information, at least one piece of candidate sound information matching the feature information.

The sound selection unit 1423 is configured to select, from the at least one piece of candidate sound information, candidate sound information satisfying a second condition as the first sound information.

In an exemplary embodiment, the sound matching unit 1422 is configured to: select, from the sound information database and according to text feature information in the feature information and a text label corresponding to each piece of sound information, at least one piece of candidate sound information matching the text feature information, the text label being used for indicating a text corresponding to the sound information; or select, from the sound information database and according to scenario feature information in the feature information and a scenario label corresponding to each piece of sound information, at least one piece of candidate sound information matching the scenario feature information, the scenario label being used for indicating a transmission scenario corresponding to the sound information; or select, from the sound information database and according to emotion feature information in the feature information and an emotion label corresponding to each piece of sound information, at least one piece of candidate sound information matching the emotion feature information, the emotion label being used for indicating an emotion corresponding to the sound information.

In an exemplary embodiment, the feature acquisition module 1410 is configured to perform text extraction on text information in the first emoji package to obtain text feature information of the first emoji package, the feature information including the text feature information; or perform feature extraction on the first emoji package, an associated chat message of the first emoji package, and an associated chat scenario of the first emoji package to obtain scenario feature information of the first emoji package, the feature information including the scenario feature information; or perform feature extraction on the first emoji package and the associated chat message of the first emoji package to obtain emotion feature information of the first emoji package, the feature information including the emotion feature information.

In an exemplary embodiment, as shown in FIG. 15, the sound generation module 1430 includes a text acquisition unit 1431, a sound interception unit 1432, and a sound generation unit 1433.

The text acquisition unit 1431 is configured to acquire text information included in the first emoji package.

The sound interception unit 1432 is configured to intercept a sound clip including the text information from the first sound information according to the text information.

The sound generation unit 1433 is configured to generate the associated sound information of the first emoji package based on the sound clip.

In an exemplary embodiment, the sound generation unit 1433 is configured to adjust a playback duration of the sound clip based on a playback duration of the first emoji package in a case that the first emoji package is a video animation, to obtain the associated sound information of the first emoji package, a playback duration of the associated sound information of the first emoji package being the same as the playback duration of the first emoji package.

In an embodiment, as shown in FIG. 15, the apparatus 1400 further includes a sound collection module 1440.

The sound collection module 1440 is configured to: collect a plurality of pieces of historical sound information transmitted by a sender account of the first emoji package; perform text conversion on a sound included in each piece of the historical sound information to obtain a text label corresponding to each piece of the historical sound information; obtain a scenario label corresponding to each piece of the historical sound information based on a transmission scenario corresponding to each piece of the historical sound information; and obtain an emotion label corresponding to each piece of the historical sound information based on a sound emotion corresponding to each piece of the historical sound information.

Accordingly, in a technical solution provided in this embodiment of this disclosure, the first sound information associated with the first emoji package is obtained by matching through the feature information of the first emoji package, which improves the degree of matching between the first sound information and the first emoji package, thereby realizing high accuracy of the associated sound information subsequently generated based on the first sound information. Moreover, the associated sound information of the first emoji package may be generated through the existing sound information in the sound information database, without a need of special dubbing and recording for the first sound information. In addition, the sound information in the sound information database is applicable to a plurality of emoji packages, so that the associated sound information corresponding to the plurality of emoji packages may be acquired without a need of dubbing and recording for the emoji packages one by one, which improves the efficiency of generating the associated sound information, and reduces the generation overheads and time costs of the associated sound information.

In the apparatus provided in the above embodiment, only division of the functional modules is illustrated. In actual application, the functions may be assigned to different functional modules for completion as required. In other words, an internal structure of the device is divided into different functional modules to complete all or some of the functions described above. In addition, the apparatus in the above embodiment may be configured to implement any of the methods. For an exemplary implementation thereof, reference may be made to the method embodiment.

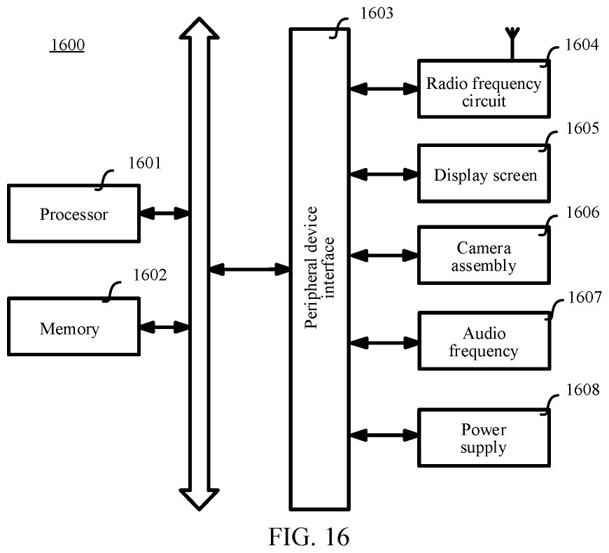

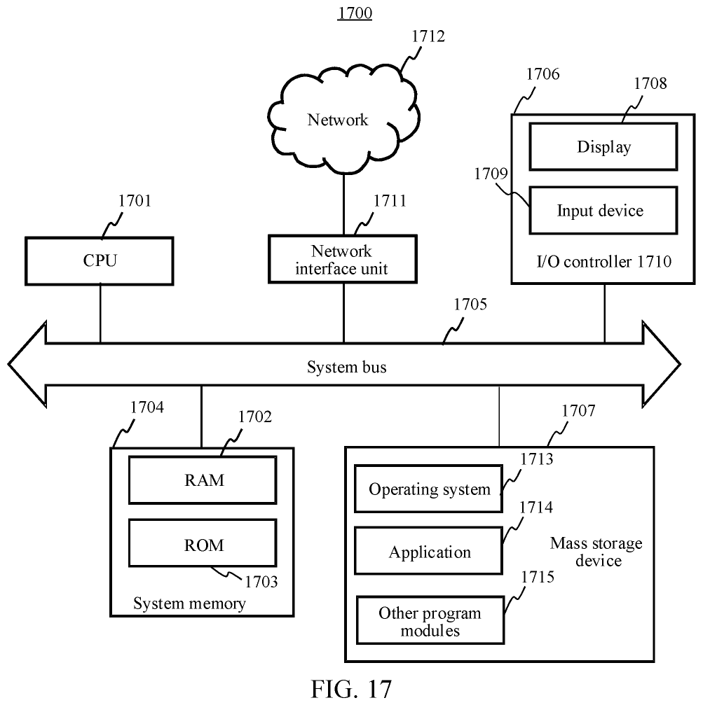

FIG. 16 is a structural block diagram of a terminal device 1600 according to an embodiment of this disclosure. The terminal device 1600 may be an electronic device such as a mobile phone, a tablet computer, a game console, an e-book reader, a multimedia playback device, a wearable device, an on-board terminal, or a PC. The terminal device is configured to implement the emoji package display method or the method for acquiring an associated sound of an emoji package provided in the above embodiments.

Generally, the terminal device 1600 includes a processor 1601 and a memory 1602.

Processing circuitry, such as the processor 1601 may include one or more processing cores, for example, a 4-core processor or an 8-core processor. The processor 1601 may be implemented by using at least one of the following hardware forms: digital signal processing (DSP), a field-programmable gate array (FPGA), or a programmable logic array (PLA). The processor 1601 may alternatively include a main processor and a coprocessor. The main processor is configured to process data in a wake-up state, which is also referred to as a central processing unit (CPU). The coprocessor is a low-power processor configured to process data in a standby mode. In some embodiments, the processor 1601 may be integrated with a graphics processing unit (GPU). The GPU is configured to render and draw content that needs to be displayed on a display screen. In some embodiments, the processor 1601 may further include an artificial intelligence (AI) processor. The AI processor is configured to process computing operations related to machine learning.

The memory 1602 may include one or more computer-readable storage media that may be non-transitory. The memory 1602 may further include a high-speed random access memory and a non-volatile memory, for example, one or more magnetic disk storage devices and flash memory storage devices. In some embodiments, a non-transient computer-readable storage medium in the memory 1602 is configured to store at least one instruction, at least one program, a code set, or an instruction set, and is configured to be executed by one or more processors to implement the above emoji package display method or the above method for acquiring an associated sound of an emoji package.

In some embodiments, the terminal device 1600 further includes a peripheral device interface 1603 and at least one peripheral device. The processor 1601, the memory 1602, and the peripheral device interface 1603 may be connected through a bus or a signal line. Each peripheral device may be connected to the peripheral interface 1603 through a bus, a signal line, or a circuit board. For example, the peripheral device includes at least one of a radio frequency circuit 1604, a display screen 1605, a camera assembly 1606, an audio circuit 1607, or a power supply 1608.

A person skilled in the art may understand that the structure shown in FIG. 16 does not constitute a limitation on the terminal device 1600, and may include more or fewer components than illustrated, or combine some components, or adopt different components arrangements.

FIG. 17 is a structural block diagram of a server according to an embodiment of this disclosure. The server is configured to implement the method for acquiring an associated sound of an emoji package provided in the above embodiment.

The server 1700 includes a CPU 1701, a system memory 1704 including a random access memory (RAM) 1702 and a read-only memory (ROM) 1703, and a system bus 1705 connecting the system memory 1704 and the CPU 1701. The server 1700 further includes a basic input/output (I/O) system 1706 for facilitating information transmission between various devices in a computer and a mass storage device 1707 configured to store an operating system 1713, an application 1714, and other application modules 1715.

The basic I/O system 1706 includes a display 1708 configured to display information and an input device 1709 such as a mouse and a keyboard for a user to input information. The display 1708 and the input device 1709 are both connected to the CPU 1701 through an I/O controller 1710 connected to the system bus 1705. The basic I/O system 1706 may further include the I/O controller 1710 for receiving and processing input from a plurality of other devices such as a keyboard, a mouse, or an electronic stylus. Similarly, the I/O controller 1710 further provides output to a display screen, a printer, or other types of output devices.

The mass storage device 1707 is connected to the CPU 1701 through a mass storage controller (not shown) connected to the system bus 1705. The mass storage device 1707 and an associated computer readable medium thereof provide non-volatile storage for the server 1700. In other words, the mass storage device 1707 may include a computer-readable medium (not shown) such as a hard disk or a compact disc read-only memory (CD-ROM) drive.

Without loss of generality, the computer-readable medium may include a computer storage medium and a communication medium. The computer storage medium includes volatile and non-volatile media, and removable and non-removable media implemented by using any method or technology used for storing information such as computer-readable instructions, data structures, program modules, or other data. The computer storage medium includes a RAM, a ROM, an erasable programmable ROM (EPROM), an electrically erasable programmable ROM (EEPROM), a flash memory or other solid-state memory technologies, a CD-ROM, a digital versatile disc (DVD) or other optical memories, a tape cartridge, a magnetic cassette, a magnetic disk memory, or other magnetic storage devices. Certainly, those skilled in the art may learn that the computer storage medium is not limited to the above. The above system memory 1704 and mass storage device 1707 may be collectively referred to as a memory.

According to various embodiments of this disclosure, the server 1700 may be further connected to a remote computer on a network for running through a network such as the Internet. In other words, the server 1700 may be connected to a network 1712 through a network interface unit 1711 connected to the system bus 1705, or may be connected to other types of networks or remote computer systems (not shown) through the network interface unit 1711.

In an exemplary embodiment, a computer-readable storage medium is further provided, storing a computer program, the computer program, when executed by a processor, implementing the above emoji package display method or implement the above method for acquiring an associated sound of an emoji package.

The computer-readable storage medium may include a ROM, a RAM, a solid state drive (SSD), a disk, or the like. The RAM may include a resistance RAM (ReRAM) and a dynamic RAM (DRAM).

In an exemplary embodiment, a computer program product is provided, including a computer program, the computer program being stored in a computer-readable storage medium, and a processor reading the computer program from the computer-readable storage medium and executing the computer program to implement the above emoji package display method or implement the above method for acquiring an associated sound of an emoji package.

One or more modules, submodules, and/or units of the apparatus can be implemented by processing circuitry, software, or a combination thereof, for example. The term module (and other similar terms such as unit, submodule, etc.) in this disclosure may refer to a software module, a hardware module, or a combination thereof. A software module (e.g., computer program) may be developed using a computer programming language. A hardware module may be implemented using processing circuitry and/or memory. Each module can be implemented using one or more processors (or processors and memory). Likewise, a processor (or processors and memory) can be used to implement one or more modules. Moreover, each module can be part of an overall module that includes the functionalities of the module.

The information (including but not limited to device information of an object and personal information of an object), data (including but not limited to data used for analysis, stored data, and displayed data), and signals in this disclosure are all authorized by the object or fully authorized by all parties, and collection, use, and processing of relevant data need to comply with relevant laws, regulations, and standards of relevant countries and regions. For example, the sender account, the receiver account, the identification information, the historical sound information, and the like in this disclosure were obtained after full authorization.

It should be understood that the term “a plurality of” in the description means two or more. “And/or” means that there may be three types of relationships. For example, AB may indicate the following cases: only A exists, both A and B exist, and only B exists. The character “/” generally indicates that the associated objects at front and rear are in an “or” relationship. In addition, the step numbers described herein merely exemplarily show an exemplary execution sequence of the steps. In some other embodiments, the steps may not be performed according to the number sequence. For example, two steps with different numbers may be performed simultaneously, or two steps with different numbers may be performed according to a sequence reverse to the sequence shown in the figure. This is not limited in the embodiments of this disclosure.

The use of “at least one of” or “one of” in the disclosure is intended to include any one or a combination of the recited elements. For example, references to at least one of A, B, or C; at least one of A, B, and C; at least one of A, B, and/or C; and at least one of A to C are intended to include only A, only B, only C or any combination thereof. References to one of A or B and one of A and B are intended to include A or B or (A and B). The use of “one of” does not preclude any combination of the recited elements when applicable, such as when the elements are not mutually exclusive.

The above descriptions are merely exemplary embodiments of this disclosure, and are not intended to limit this disclosure. Any modification, equivalent replacement, or improvement made within the spirit and principle of this disclosure shall fall within the protection scope of this disclosure.

What is claimed is:

1. A method for audio-enabled messaging of an image, comprising:
displaying a messaging interface;
displaying an image selection interface in response to a first user operation via the messaging interface, the image selection interface being configured to display at least one image for selection by a user; and
displaying, in the messaging interface, an audio-enabled message that includes an image that is selected from the at least one image by the user, the audio-enabled message including the selected image and audio information that is determined to be associated with the selected image.

2. The method according to claim 1, wherein the image includes an emoji.

3. The method according to claim 1, wherein the displaying the audio-enabled message comprises:
determining a messaging mode of the selected image; and
based on the messaging mode being an audio-enabled messaging mode,
sending the audio-enabled message including the selected image to another user, and
displaying, in the messaging interface, the audio-enabled message that includes the selected image based on the messaging mode being the audio-enabled messaging mode.

4. The method according to claim 3, further comprising:
displaying a messaging mode switch control element for the selected image based on a user selection of the image; and
setting the messaging mode to one of the audio-enabled messaging mode and an audio not enabled messaging mode based on a second user operation performed on the messaging mode switch control element.

5. The method according to claim 1, further comprising:
playing back the associated audio information of the selected image in response to a playback operation being performed on the audio-enabled message.

6. The method according to claim 1, further comprising:
in response to an audio changing operation being performed on the selected image,
selecting candidate audio information satisfying a first condition from at least one piece of candidate audio information to generate replacement audio information for the selected image, the candidate audio information being selected according to feature information of the selected image and label information corresponding to each piece of previously stored audio information; and
replacing the associated audio information of the selected image with the replacement audio information.

7. The method according to claim 1, further comprising:
in response to an audio changing operation being performed on the selected image,
displaying at least one piece of candidate audio information;
generating replacement audio information for the selected image according to target audio information that is selected from the at least one piece of candidate audio information by the user; and
replacing the associated audio information of the selected image with the replacement audio information.

8. The method according to claim 1, wherein
the selected image is included in a video, and
the audio-enabled message includes the video.

9. A method for obtaining audio information for an audio-enabled message, the method comprising:
obtaining feature information of an image to be included in the audio-enabled message;
obtaining audio information that is determined to be associated with the image according to the feature information; and
generating associated audio information of the image to be included in the audio-enabled message with the image based on the obtained audio information.

10. The method according to claim 9, wherein the image includes an emoji.

11. The method according to claim 9, wherein the obtaining the audio information comprises:
selecting, according to label information corresponding to each piece of previously stored audio information, at least one piece of candidate audio information that matches the feature information; and
selecting, from the at least one piece of candidate audio information, candidate audio information that satisfies a second condition as the audio information.

12. The method according to claim 9, wherein the obtaining the feature information comprises:
performing text extraction on text information in the image to obtain text feature information of the image, the feature information including the text feature information.

13. The method according to claim 9, wherein the obtaining the feature information comprises:
performing feature extraction on at least one of the image, an associated message of the image, or an associated messaging scenario of the image to obtain scenario feature information of the image, the feature information including the scenario feature information.

14. The method according to claim 9, wherein the obtaining the feature information comprises:
performing feature extraction on at least one of the image or the associated message of the image to obtain emotion feature information of the image, the feature information including the emotion feature information.

15. The method according to claim 9, wherein the generating the associated audio information comprises:
obtaining text information included in the image;
extracting an audio clip corresponding to the text information from the audio information; and
generating the associated audio information of the image based on the audio clip.

16. The method according to claim 15, wherein
the generating the associated audio information includes adjusting a playback duration of the audio clip based on a playback duration of a video that includes the image to obtain the associated audio information of the image, and
a playback duration of the associated audio information of the first image is equal to the playback duration of the video that includes the image.

17. The method according to claim 9, further comprising:
storing a plurality of pieces of audio information that are previously sent by the user,
wherein the obtaining the audio information includes obtaining the audio information from the plurality of pieces of previously sent audio information that is determined to be associated with the image according to the feature information.

18. An information processing apparatus, comprising:
processing circuitry configured to:
display a messaging interface;
display an image selection interface in response to a first user operation via the messaging interface, the image selection interface being configured to display at least one image for selection by a user; and
display, in the messaging interface, an audio-enabled message that includes an image that is selected from the at least one image by the user, the audio-enabled message including the selected image and audio information that is determined to be associated with the selected image.

19. A non-transitory computer-readable storage medium, storing instructions which when executed by a processor cause the processor to implement the method according to claim 1.

20. A non-transitory computer-readable storage medium, storing instructions which when executed by a processor cause the processor to implement the method according to claim 9.
